(19) United States
(12) Patent Application Publication
(10) Pub. No.: US 2007/0219816 A1
(43) Pub. Date: Sep. 20, 2007

(54) System and Method of Prioritizing Items in a Queue

(75) Inventors: Andrew S. Van Luchene, Santa Fe, NM (US); Raymond J. Mueller, Palm Beach Gardens, FL (US)

Correspondence Address: GONZALES PATENT SERVICES, 4605 CONGRESS AVE. NW, ALBUQUERQUE, NM, 87114, US

(73) Assignee: Leviathan Entertainment, LLC, Santa Fe, NM (US)

(21) Appl. No.: 11/611,024

(22) Filed: Dec. 14, 2006

Related U.S. Application Data
(63) Continuation-in-part of application No. 11/462,621, filed on Aug. 4, 2006.
(60) Provisional application No. 60/727,191, filed on Oct. 14, 2005.

(51) Int. Cl. G06Q 10/00; G06Q 30/00

(52) U.S. Cl. 705/1

(57) ABSTRACT

A system and method of prioritizing items in a queue is provided. The system and method includes the creation of a document queue comprising a plurality of items and the assignment of a queue position to each of the plurality of items based upon one or more determining factors, such as the date of receipt of each item. A fee can be calculated for moving an item to a different priority queue position and a right-of-first refusal can be provided for one or more items that would have their respective queue positions changed as a result of payment of the fee.

### CROSS-REFERENCE TO RELATED APPLICATIONS

This application is a continuation-in-part application of U.S. patent application Ser. No. 11/462,621, filed Aug. 4, 2006 which claims the benefit of U.S. Provisional Application No. 60/727,191, filed Oct. 14, 2005. Each of the foregoing applications is hereby incorporated by reference in their entirety.

### FIELD OF THE INVENTION

The present teachings relate to a system and method of prioritizing items that are arranged in a queue. In particular, the present teachings relate to a system and method that can create a queue of submitted items and allows the prioritization of certain items within the queue upon the payment of calculated fees and the exercise of right-of-first refusals.

### BACKGROUND OF THE INVENTION

Many business entities and individuals process various types of items such as applications, claims, and other documents. Typically, prioritization of such items is based upon the date received and/or the relative importance of the applicant, such as a customer, client, business account, etc. Oftentimes entities may be overwhelmed by the number of items in the queue to process and, in these instances, adequate levels of service may be jeopardized. In certain cases, such as with insurance companies, local, State and/or Federal laws may control the method and means for the timing, priority, and processing of respective forms, even though, in some cases, several forms may have greater value to the applicant or processing entity and/or may have some aspect that provides a degree of “perishability”. Applicants who might need or otherwise desire faster processing of their forms are left with little choice except to wait in line for their submissions to be processed according to their assigned position in the queue, even in instances where they may be willing to pay for prioritized processing.

Accordingly, there exists a need for a system and method that allow applicants who have submitted items into a queue the opportunity to obtain priority status and resolution over other items that are arranged within the queue.

### SUMMARY OF THE INVENTION

The present teachings disclose a system and method of prioritizing items that are arranged in a queue.

In particular, a method of the present teachings includes creating a document queue including a plurality of items and assigning a queue position to each of the plurality of items based upon one or more determining factors. The method calculates a fee for moving an item to a different priority queue position and provides a right-of-first refusal for one or more items that would have their respective queue positions changed as a result of payment of the fee. Upon the payment of the fee and a waiver of one or more right-of-first refusals, the method includes moving the item to the different priority queue position in the document queue.

According to a further embodiment of the present teachings, a method includes creating a document queue comprising two or more items to be processed. The method further includes assigning a queue position to each of the two or more items in the document queue based upon one or more determining factors, and determining a processing date for each item. The method also includes calculating a movement cost value for moving a particular item to one or more higher queue positions in the document queue and providing a right-of-first refusal for each item which would have its respective queue position lowered as a result of an accepted payment of a movement cost value.

According to the present teachings, a system of prioritizing items having filing dates is provided. The system includes an assignment component capable of receiving two or more items filed by respective applicants and assigning a queue position for each item. The system also includes a document queue component capable of ordering the two or more items in a document queue by the assigned queue position and being associated with an agent capable of processing the items. The system further includes a processing time component capable of ascertaining and notifying an applicant of a resolution date for each respective item in the document queue. Moreover, the system includes a priority resolution component capable of determining whether an item has qualified to move to a different queue position based upon the payment of a priority queuing fee and the exercise of one or more right-of-first refusals by applicants who would have their respective queue positions changed as a result of payment of the priority queuing fee.

Additional features and advantages of various embodiments will be set forth, in part, in the description that follows, and, in part, will be apparent from the description, or may be learned by practice of various embodiments. The objectives and other advantages of various embodiments will be realized and attained by means of the elements and combinations particularly pointed out in the description herein.

### DETAILED DESCRIPTION OF THE PREFERRED EMBODIMENTS

A queue can define a sequence of items, which are each considered to be “in” or “included in” the queue. Generally, a queue defines a sequence of “positions” to which the items in the queue are assigned. For example, a queue of documents (e.g., patent applications) defines a sequence of documents. The “top” or “head” of the queue is an end of the sequence, and is typically the end at which items are processed or acted on (e.g., an application can be processed by being examined, in whole or in part). Typically, the “top” is the one position that is defined to be “ahead of” or “higher than” all other positions. Comparative terms such as “ahead of” or “higher than” indicate that something is closer to the top of a queue than another item. Similarly, terms such as “behind” or “lower than” indicate that something is farther from the top of a queue than another item.

Movement of an item in a queue can be in an “up” direction (i.e. its position becomes closer to the top) or in a “down” direction (i.e. its position becomes farther from the top). Generally, movement of an item in a queue changes the position of that item relative to one or more other items in the queue. The sequence of items in the queue can define a time order—i.e. some items in the queue are processed or handled before other items, depending on their respective positions in the queue. The “top” of the queue can represent the position that is earliest in time order (e.g., something at the top of the queue is processed or handled before all other items in the queue). In addition or in the alternate, the sequence can define a value order—i.e. some items in the queue are considered (in some way) more valuable/more costly than other items depending on the position in the queue. The “top” of the queue can represent the most valuable/most costly (e.g., something at the top of the queue is the most valuable/most costly). In another embodiment, the “top” of the queue can represent the least valuable/least costly. In one embodiment, the queue can be such that each item (e.g., each patent application) in the queue is either “ahead of” (e.g., handled earlier than) or “behind” (e.g., handled later than) any other item in the queue. In such an embodiment, given any two items in the queue, exactly one of the two is “ahead of” the other of the two. In such an embodiment, each item (e.g., application) can be assigned to a position in the queue.

In addition or in the alternative, a queue can be such that given any two items in the queue, it is not necessarily true that exactly one of the two is “ahead of” the other of the two. For example, the queue can define a sequence of sets of items, and each set can be assigned to a position in the queue. For example, the queue can be such that each set of items (e.g., each of a plurality of sets of patent applications) in the queue is either “ahead of” or “behind” any other set in the queue. In such an embodiment, given any two sets in the queue, exactly one set is “ahead of” the other set. However, in an embodiment, it may be undefined whether any item in a set is ahead of or behind any other item in that set. For example, such a set could represent a block of work to be done. In an embodiment, it need not be true that everything in a queue is assigned to a set. On the contrary, in an embodiment, a queue may only define, e.g., one set, such as a set of a predetermined number of items at predetermined positions. For example, a set may represent all the positions within a certain number of positions of the top (e.g., the thirty positions nearest to the top of the queue, including the top of the queue). Such a set can be used in many manners. For example, the items (e.g., applications) in such a set can be processed before items that are not in that set, but the items in the set can be processed in any order (not necessarily starting from top and proceeding to each position after the top). In an embodiment where there are sets of items (e.g., applications) in a queue, an item may be assigned to exactly one set, such that an item cannot be included in more than one set. In an embodiment where there are sets of applications (e.g., or other items) in a queue, each application can be assigned to a set. Thus, in such an embodiment all sets in the queue necessarily include all applications (i.e. no application fails to be included in at least one set). The queue can be otherwise arranged so that further types of sequencing can be implemented besides those specifically and explicitly described herein.

In addition or in the alternative, a queue can mean any one or more of the following, including: A group of two or more patent applications awaiting processing, a line of people, a group of documents awaiting printing, a document or computer instruction awaiting processing, a list of customers waiting for a call center employee to answer the call, a line of cars waiting to go through a toll booth, a group of shipping containers waiting to be loaded or unloaded from a ship, baggage waiting to be unloaded or loaded to/from an airplane or train, and/or waiting to be delivered at an airport baggage claim area or belt, a stack of forms waiting processing by an insurance company employee or a computer processing system, a waiting list of those wishing to purchase a good or service, a list of those wishing to purchase tickets to an event, people in a waiting room (e.g., those waiting to obtain a driver's license or other government permit) or emergency room, etc.

A queue may list items individually and/or may process groups or blocks of items. In an embodiment, such groups may be processed and/or moved within a queue as a whole and may or may not be permitted to be separated from each other. A queue, may be FIFO (first in, first out) or LIFO (last in, first out), or may be processed based upon any one or more criteria including: need, payments, characteristics of the person or item to be processed, e.g., the age and/or health of the applicant, or the relative value of the item as compared with others waiting in the queue. Initial and subsequent positioning within one or more given queues may be manually adjusted and/or automatically adjusted using any of one or more criteria listed and/or based upon costs/payments, etc. Resources to process an application in a queue may be assigned at the same time or generally the same time as assignment to the queue, or at some other time, e.g., when the application is at the end of the queue, start or finish and/or at some other point within the queue. Anything may be done within a queue including automatically, manually, or a combination of these. A queue may include more than one queue. In addition or in the alternate, a queue may itself include one or more queues, which each may in turn contain one or more additional queues, and so on.

Item—includes anything (including tangible and intangible items, pointers or tokens that represent a tangible or intangible item) that can be placed into and/or moved within, or pointed or traced within a queue or sorted or resorted in a particular order including: documents (physical or digital or links to digital documents), images, insurance forms including insurance applications and insurance claim forms, cars, parts, inventory items, cases of goods, pallets of goods, containers of goods, food items, raw or finished goods, cases, e.g., a lawsuit or demand or judgment or award, people, animals, pointers, e.g., a database entry or token, list, index, and the like, baggage, clothing, tasks or task lists (e.g., to do lists), computer instructions, i.e., awaiting processing and/or operating system commands.

Agent—includes the agent or person or system responsible for processing, examining, handling, routing, managing, or reviewing an item. An agent may be any one or more of a person, such as a dock worker, a stocking boy, a Transportation Services Agency employee, an application examiner, insurance examiner, patent examiner, or a gate agent or flight attendant or baggage handler, or any other person responsible for processing, examining, reviewing, routing, managing or otherwise is generally responsible for an item, and/or, a group of items, and/or a queue or group of queues, for example, a computer program, such as an automated baggage handling system used for directing or sorting or identifying baggage, or a computer program designed to determine an item's characteristics, queue assignment, queue position or priority, agent assignment, queue position or priority changes, agent change application, and the like.

Applicant—includes any person or computer program that submits an item for processing to a queue or to another person or computer for submission into a queue. For example, insurance applicants and/or claimants, or employees of insurance or other companies, airline passengers, patent applicants, defendants, plaintiffs, lawyers, or any other person or entity that owns, manages, or otherwise is generally responsible for or controls items that are in or are to be submitted to a queue or a group of queues or that are to be processed.

Artificial Intelligence—includes any computer program that uses neural nets and genetic algorithms.

Date Stamp—Includes an electronic, unalterable stamp on an electronic file indicating the date that the file was created or received by a computer system.

Genetic Algorithm—includes a computer algorithm that is capable of modifying and improving itself over time.

Time Stamp—includes an unalterable recording of the time a document was created by, entered into, or received by a system.

The term “product” means any machine, manufacture and/or composition of matter, as well as any other created item that can be protected by or that can infringe the claims of an issued patent, unless expressly specified otherwise.

The term “process” means any process, algorithm, method, decision, action or the like, unless expressly specified otherwise. For example, process includes, but is not limited to: the review of a form, examining a document, managing a form or group of forms, making a decision about the contents of a form, sorting an item (manually or automatically), moving or taking possession (temporarily or otherwise) of an item, e.g., moving baggage into a baggage cart or moving baggage to a sorting area, placing a document in a stack of documents or in a file of physical or electronic documents, inserting an item into a queue, removing an item from a queue, making a decision, storing or processing information, e.g., in a computer system and/or within a human being's brain, reading a website or other computer display or document, filling in a form on a website or other computer application, etc.

Each process (whether called a method, algorithm, decision, action, or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed teachings”, unless expressly specified otherwise.

The term “variation” as used in the teachings means an embodiment of the teachings unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising”, and variations thereof mean “including but not limited to”, unless expressly specified otherwise.

The term “consisting of” and variations thereof mean “including and limited to”, unless expressly specified otherwise.

The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of items (such as an enumerated list of items), means any combination of one or more of those items, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective, or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other items besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like. Such determinations may be made by any method, including via automated computer calculations and/or human actions or steps.

The term “determining” does not imply but may include certainty or absolute precision, and therefore “determining” can include estimating, predicting, guessing and the like.

The term “determining” does not imply that mathematical processing must be performed or that numerical methods must be used, and does not imply that an algorithm or process is used.

The term “determining” does not imply that any particular device must be used. For example, a computer need not necessarily perform the determining.

It will be readily apparent to one of ordinary skill in the art that the various processes described herein may be implemented by, e.g., appropriately programmed general purpose computers and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus, a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor, or a like device. Such a medium may take many forms, including, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, and the like, such as Ethernet (or, e.g., IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus, a description of a process is likewise a description of a computer-readable medium storing a program for performing the process. The computer-readable medium can store (in any appropriate format) those program elements, which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases and/or rules databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only and one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, VPN, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino® processor, that are adapted to communicate with the computer. Any number and type of devices may be in communication with the computer.

According to various embodiments, a server computer or centralized authority may not be necessary or desirable. For example, the present teachings may, in an embodiment, be practiced on one or more devices without a central authority, e.g., in a peer-to-peer network. In such an embodiment, any functions described herein as performed by the server computer or data described as stored on the server computer may instead be performed by or stored on one or more such devices.

Various embodiments of the present teachings generally relate to the submission of items (e.g., documents to be processed) to queues and/or the initial and/or subsequent prioritization of items in queues and/or the processing of items from queues. One embodiment includes a method of insertion of an item into a queue. Another embodiment includes a method of assigning an initial position and/or an initial priority to an item in a queue. In certain embodiments, items may receive higher priority over other items that were submitted earlier. For example, an applicant (who's item is in a queue) might receive preference or higher priority for their item, if the applicant pays a fee (e.g., a predetermined fee) and/or is otherwise eligible to receive priority treatment due to certain characteristics of applicant or applicant's item, such as, for example, the applicant's age or the inherent or determined value of applicant's item within the queue. In yet another embodiment, items in queues are assigned to agents for subsequent processing. Such assignment (e.g., which agents process which items) may be based upon certain characteristics of the item and/or the agent (e.g., subject matter of the item).

In another embodiment, a queue can be generally considered to have a “length” that is generally the number of positions in the queue. Items can be added to a queue (e.g., inserted at the end of a queue), thereby increasing the length of the queue. Similarly, removing items from a queue can decrease the length of the queue.

Various methodologies may be used to refer to the positions of a queue. In an embodiment, each position in a queue can be identified by a number, in which the top is referred to by a number (e.g., “1”) and each position is referred to by a number that is “1” greater than that of the position immediately ahead of it. Thus, the positions starting from the top may be referred to as “1”, “2”, “3”, etc.

Many alternative methodologies for referring to positions may be used. In various alternative methodologies, the reference to a position may itself define information instead of or in addition to the position's distance from the top of the queue. For example, the reference may include information regarding the item at that position.

An application or item may need to satisfy one or more criteria before that application may be inserted in a queue.

In an embodiment, a system and/or method includes a plurality of queues in which each queue is assigned to handle different categories of items or things (e.g., different categories of patent applications, such as those directed to different types of technology). In such an embodiment, in order for an application to be inserted into a queue, that application would need to be of the appropriate category. For example, there may be a system and/or method where there are three queues each corresponding to one of the following categories of technology, chemical, software, and biotechnology. In such a system, an application which is directed to chemical technology would satisfy the condition for insertion into the chemical queue. Another example includes a system and/or method where there are a number of queues each corresponding to a particular application type or status. With respect to patent applications, such queues can include, for example, regular new applications, special new applications, regular amended applications, special amended applications, accelerated new applications, accelerated amended applications, and rejected applications.

In an embodiment where an application must satisfy a criterion to be inserted in a queue, there can be a system or process by which all applications are first inserted into one or more “category queues”. In an embodiment, a category queue is a queue which holds all applications (e.g., in order based on filing date) for a determination of which category an application is in. For example, a category queue can include a pre-classification division which arranges and holds patent applications as they await initial patent classification based upon a review of their claims. At the pre-classification division, patent applications can be arranged or transferred into an electronic format, referred to as an image file wrapper, having particular assigned information and formatting. Patent applications which are not filed electronically can be scanned into an electronic format and then formatted into an image file wrapper.

The claims of the image file wrapper can be reviewed and an initial classification assigned to the application. The initial classification can be assigned in an automated manner by way of, for example, a computer algorithm, or by way of human review.

A queue arranged ‘downstream’ from the pre-classification division can include an electronic mailbox assigned to a supervisory patent examiner (or his or her designee) who works in a particular general area of technology or ‘Technology Center’. Patent applications that have been initially classified can be submitted to the electronic mailbox of a supervisory patent examiner (or his or her designee) who supervises one or more examiners having the general technological expertise needed to examine the patent application (as determined by the initial classification assigned to each patent application). The supervisory patent examiner (or his or her designee) can then assign each of the patent applications in his or her mailbox to an appropriate examiner's queue or docket for examination by that examiner at a later date. The assignment of a patent application to an examiner's queue can be accomplished by, for example, assigning an employee number to the patent application. Examiners can review one or more of their queues, such as, for example, their regular new application queue, by accessing a secure database which lists new applications assigned to their employee number.

A supervisory patent examiner and the one or more examiners that are supervised by that supervisory patent examiner can be referred to as an ‘Art Unit’. Two or more ‘Art Units’ can be grouped together to form a ‘Work Group’. One or more ‘Art Units’ and/or one or more “Work Groups’ can form a ‘Technology Center’. Several ‘Technology Centers’ form the examining corps of the U.S. Patent and Trademark Office. A patent application can move from the pre-classification division category queue to one or more other queues, such as, for example, a ‘Work Group’ queue, before being submitted to the electronic mailbox of a supervisory patent examiner. Moreover, a patent application that has been improperly assigned to an examiner can be transferred to, for example, a different examiner, supervisory patent examiner, ‘Work Group’, ‘Technology Center’, and/or back to the pre-classification division.

Patent applications assigned to a particular examiner can be arranged in one or more queues designated to that examiner. For example, any particular examiner could have assigned to him or her one or more of the following queues: regular new applications, regular amended applications, special new applications, special amended applications, accelerated new applications, accelerated amended applications, rejected applications, as well as others. The regular new queue can include all newly filed patent applications which are awaiting a first examination by the assigned examiner. The special new queue can include all newly filed ‘special’ patent applications which are awaiting a first examination by the assigned examiner. Such ‘special’ patent applications can include the following application types: continuations, divisionals, reissues, reexaminations, PCTs, petition to make specials, and the like. The regular amended queue can include all non-special patent applications in which a response, such as an amendment, has been filed. The special amended queue can include all ‘special’ patent applications in which a response, such as an amendment, has been filed. The accelerated new queue can include all newly filed patent applications submitted under the accelerated examination program which are awaiting a first examination by the assigned examiner. The accelerated amended queue can include all patent applications submitted under the accelerated examination program in which a response, such as an amendment, has been filed. The rejected application queue can include all applications in which an office action has been issued by the examiner and a possible response from an applicant is being waited on.

How to submit something to a queue:

One or more applicants or any person or computer software application may submit one or more “items” directly or indirectly to one or more queues. Insertion into a queue may be at the start of the queue, i.e., the beginning or bottom of the queue, or it may be at some other predetermined or determined mid-point or even at the top or end of the queue. There may be one or more queues. The assignment of a queue position within a particular queue can be based upon one or more determining factors. Such determining factors can include, for example, time and/or date of receipt of one or more of the items.

“Items” submitted to a queue may be evaluated and/or preliminarily classified to determine i) to which queue the item should be submitted, or best fits, and ii) its priority or starting position within the queue based on the one or more determining factors. Such an evaluation and assignment can be implemented by computer algorithm or manually by a human being, or by a combination thereof.

In an embodiment, submission of an item to a queue can be made using a designated web-based form provided for such purpose.

In an embodiment, submission to a queue can mean any one of the following, including: a person standing in line, placement of one or more documents into a stack of documents (or a list or file of documents, or a pointer or pointers to digital document(s) within a list of two or more other digital documents), submitting one or more documents to a clerk and obtaining a computer generated or manual date-stamp, sending an e-mail with or without an attached document, filling out a form to request submission to a queue, sitting down in a chair, taking a number from a list of numbers, being given a number, sending or receiving an e-mail message with a number, sending an electronic or printed document (e.g., a text file, image of a document, PDF or MS Word document) to a processing office or to an examiner or agent, purchasing a premium or other airline ticket (such as a first class airline ticket which ticket includes fees for priority processing of passenger seating and/or baggage, or any ticket that includes a fee or lists an additional fee for priority seating or baggage handling), or purchasing a specific position within a queue and attaching an item or a pointer to an item in that position.

Assuming proper authorization, applicants or those in a queue (or those responsible or have control over the items in the queue, e.g., an agent) may request or access the following information:

Information about where their document (i.e., application or item) is or will be assigned;

Which queue their item is assigned to (or which queue category);

The item's position within the queue;

The number of other items in the queue (in total and ahead and/or behind them) or in the queue category;

The cost for the applicant (or others with responsibility for or an interest in the item, collectively “other interested parties”) to change the position of item one or more positions in a queue or to change the queue category;

The cost for the applicant (or other interested parties) to move their item to another queue;

The cost paid by third parties who have paid to move their item up or down one or more positions in the queue or queue category;

What third parties can or have paid to move to another queue or queue category;

The reason why their application was assigned a particular queue or a particular position within a queue or to a particular queue category;

The calculation method(s) for determining any cost (or other reasons) to move theirs or a third party's application in a queue or to another queue or to another queue category;

Updates as to the status of their position in the queue or queue category;

Updates as to requests by other third party items in the queue to change their position and/or queue and/or queue category and costs attached to each (if any);

First right-of-refusal to maintain a position, improve a position, and/or accept a lower position in one or more queues;

Option to trade a better position in one queue (e.g., for one item or document) for a less desirable position for another item/document. That is, a first applicant trades a second applicant's better position in a second queue for the first applicants' better position in a first queue. For example, I want my device patent application to receive a better position in the device queue, so I trade my better position of another pending application (e.g., a software method) with another applicant who desires the opposite condition (i.e., the second applicant wants a better position in the software method's queue) and is willing to give up his better position in the devices queue. Such a situation may be conducted with multiple parties, e.g., three parties, or more, if necessary to find all necessary positions within multiple queues;

Updates as to changes or pending or potential changes in any costs or queue activity; and

The time or estimated time to reach a given position within a queue, including the top, and/or the time to complete the processing of the application (or item);

In an embodiment, certain applications or applicants may only be able to have their application prioritized or moved ahead in the queue upon the payment of an additional fee which is used to provide at least some level of prioritization to one or more other applications. The applicants of such other applications may need to show some need, such as, for example, advanced age, economic hardship, or technological benefit (e.g. an urgently needed pharmaceutical) of their application to obtain such a subsidy.

Moving an Application in a Queue

Characteristics of Relative Movement

Things, i.e., items in a queue can be “moved”, as is described in other portions of this application.

Movement of one or more items in a queue can occur if, for example, an item is removed from the queue. For example, if an item at the top of the queue (e.g., the item is at the top) is removed from the queue, consequently the positions of every other item in the queue change positions by advancing one position towards the top (the item at position 2 before removal moves to position 1 after removal, etc.).

Movement of an item in a queue can occur if those one or more items are moved ahead of another item or items in a queue. For example, if the item at the position 5 is moved to the top (e.g., position 1) of a queue, consequently the positions of the items that (before movement) were at positions 1, 2, 3 and 4 will change by receding one position away from the top (i.e., the item at position 1 before movement moves to position 2 after movement, and so on, etc.). Tables 1 and 2 illustrate this example.

TABLE 1
Queue Before Movement

| Queue Position | Item |
|---|---|
| 1 (“Top”) | A |
| 2 | B |
| 3 | C |
| 4 | D |
| 5 | E |
| 6 | F |
| 7 | G |

TABLE 2
Queue After Movement

| Queue Position | Token |
|---|---|
| 1 (“Top”) | E |
| 2 | A |
| 3 | B |
| 4 | C |
| 5 | D |
| 6 | F |
| 7 | G |

All items in a queue may be prevented from relative movement. This may occur because no relative movement may be requested by, for example, the applicant/owner of an item in the queue. Relative movement may be permitted by, for example, the system or rules established and maintained within the system.

In general, the queue can be filled with tokens or pointers which indicate things to be processed and/or their position within a queue.

In an embodiment, there is a one-to-one correspondence between tokens and positions in a queue. In other words, each token uniquely identifies one position and each position corresponds to one token. A token can serve as a pointer to an item to be examined, for example, a record which is associated with the token identifier). At some time, for example, when it is time for a token to be processed, upon request the system determines the item to which the token “points”.

Each token can include or can be indicated by a unique identifier (e.g., a ten digit number, a sixteen character identifier, or other unique ID code).

A queue can be represented by various types of structures. For example, Table 3 shown below illustrates an embodiment of a data structure that can represent a queue of tokens. In the structure depicted in Table 3, each of a series of positions corresponds to a token identifier. Such a structure could be implemented as, e.g., a linked list, simple table, joined table, or multiple joined tables. Types of tables, pointing structures, sorting, and sequencing methods are well known by those with ordinary skill in the art and, therefore, more detailed examples are not shown.

TABLE 3
Queue Positions and Tokens

| Queue Position | Token |
|---|---|
| 1 (“Top”) | 8M12038940 |
| 2 | 8M12038941 |
| 3 | 8M12038942 |
| 4 | 8M12038943 |
| 5 | 8M12038944 |
| 6 | 8M12038945 |
| 7 | 8M12038946 |

As shown in Table 4 below, each token could correspond to an item, such as by storing an item serial number or other ID number. For example, a database can be arranged to store for each of a plurality of tokens a corresponding item ID number. Such a database could also store, for each token, further information such as a communication record (e.g., correspondence address, phone number, email). Such a communication record may itself be stored by the application and thus would be accessible from the application.

TABLE 4
Tokens

| Token | Item ID Number. |
|---|---|
| 8M12038940 | 11-123,456 |
| 8M12038941 | 12-234,761 |
| 8M12038942 | 11-012,263 |
| 8M12038943 | 12-923,674 |
| 8M12038944 | 12-100,931 |

Uses of Tokens

A token can be bought and sold, and thus the position in the queue can be bought and sold, e.g., by private parties on a trading system. Thus, a private market for positions in a queue can exist without significant changes by the processing office or other entity processing application in a queue. In such a situation, the processing office merely determines which application is referred to by tokens in the queue.

According to an embodiment, a token can refer to different items at different times. Thus, as a position of a token changes (e.g., a particular token moves towards the top) that token may refer to the same item the entire time, or alternatively, may refer to different items at different times.

Descriptions herein of actions performed on items in a queue are applicable to a queue of tokens where the tokens refer to the items in the queue.

Although a single queue has been used in many examples within this disclosure, it would be obvious to one of ordinary skill in the art that the creation of multiple queues and/or groups or categories of multiple queues could be used to segment and/or categorize various items based upon any one or more of an items' distinguishing characteristics and/or those of the applicant and/or those of the agent assigned for subsequent processing, and/or certain queues established to initially record the submission of an item to a queue, and then subsequent transferal of the item from an initial first queue, to a second, more defined queue, and/or to a second queue which is assigned to one or more or a group of agents for processing or subsequent prioritization.

Reentry to a Queue

In the event, for any reason or no reason, an item is removed from a queue, such an item may be permitted to reenter into the queue. Such reentry may be determined based upon the same rules and conditions and methods for entry of a new item entry into a queue, or it may be controlled via new rules and/or methods, and/or expanding or constraining rules.

In an embodiment, items are permitted reentry to a queue, or to a second or alternative queue. Such reentry may be determined based upon reentry “rights” that may be conferred upon an applicant and/or the item, and/or the queue. Such rights may provide the terms and conditions upon which an item that has been removed (prematurely or otherwise) from a queue may reenter that or a replacement queue. Such rights may be absolute or they may be limiting, for example, if an item is removed from a queue by a person other than the applicant and such removal was not authorized or permitted, applicant may petition for reentry to the same queue, or another queue for example, and receive preferential treatment, and/or simply have the removed item reentered into the same queue and into the same position within the queue, or some other position, e.g., the position the item may have been promoted to had the item not had not otherwise been removed.

In an embodiment, rights may be conferred upon the item, applicant, queue, or any person or item or third party as determined by the examining agency, an agent, and/or the owner or manager of the queue, or any other agency, company, or governing body or person with due authority to grant such rights.

In another embodiment, queue reentry rights or other rights may be purchased, sold, or auctioned.

In another embodiment, reentry of an item may require a manual step or such reentry may be accomplished automatically by a computer system.

In yet another embodiment, in the event an item is removed from a queue because it has reached the required or otherwise appropriate point within the queue to warrant removal or processing, but such item is subsequently rejected by an agent or system or other party for a specific reason or reasons or no reasons, such item may be reentered into the queue from which it came, or another queue designated for such purpose or any other queue as determined by the agent or otherwise. In an embodiment, reentry may be managed manually by, for example, the agent or the agent's supervisor, or a computing method based upon rules, and/or automatically based upon rules, and/or the item may be reinserted at some predetermined point, e.g., the top, middle or end of the queue, or some other point including the top, middle or end of the queue based upon any rules, or any discriminating factors such as the age of the applicant, or whether or not the applicant paid for priority or not, etc.

For example, whenever an examiner conducts a first examination of a patent application and a first office action is issued rejecting the application for formalities and/or informalities, that rejected application can be removed from an examiner's regular new queue and submitted into a rejected application queue where it awaits receipt of a possible response from an applicant. If a response is received within a predetermined period of time, that response is matched to the application and the application is removed from the rejected application queue and submitted into the regular amended application queue where the application awaits processing. Such a movement between queues can continue until the patent application is allowed, abandoned, or appealed.

In addition or in the alternate, despite an applicant's prior wait and/or payments to insert and/or prioritize an item, that applicant's item may be reinserted at a lowest point and the applicant may be required to pay for a change in priority of the item within the queue.

Alerts

An alert is a message or notification sent from a sender to a recipient that contains information about something that has, will or will not, or may change. For example, the sender may be a computer program and the recipient may be a person, such as an applicant, or yet another computer program. In another example, the sender may be a person and the receiver may be a computer program.

In an embodiment, applicants or other persons may request to send and/or receive alerts and/or alerts may be automatically generated and sent without prior request or approval by the applicant or other recipient.

Alerts may be triggered by any one or more of:

A manual action taken by a person;

The approach of, reaching or passing a certain time and/or date and/or specific day of the week, or holiday, or other specified or calculated date (e.g., Easter Sunday);

A change in status of one or more items and/or an items characteristics in one or more queues;

A change in status of any one or more data elements or items within any one or more databases and/or rules databases and/or end user preference files, such as a cookie on an end-user's PC or cell phone;

A percentage change in status of one or more items (i.e., variables) within one or more queues, databases or otherwise;

A request by an applicant or other person to submit an item to a queue or to change a position in a queue and/or a change or a change request to a queue category;

A request by an applicant to change queues or queue categories;

An increase or decrease in a resource assigned to a queue;

A change in any rules or other database;

A change in a policy used by an agent or processing agency maintained within a database;

A change in the price needed/expected to change an item's position within a queue and/or to change queues, and/or to change agents;

A change in the current, expected or calculated;

Rate at which items progress in a queue;

Price or payment to be received to forego or give up one or more positions in a queue;

Notice or instructions to a computer system or automated routing system and/or an agent or other examiner or human being to process or examine an item;

Completion of processing of one or more items in one or more queues;

Outcome of processing one or more items;

Cost to maintain or change a position and/or queue;

Availability of a specific agent and/or class of examiners;

Cost to move to another queue;

Cost to surrender a position in a queue;

Cost to replace one agent in preference for another agent;

Newly added, changed or deleted items (i.e., any tracked variable, e.g., number, type, scope, cost, skill levels, incentives, payments to move, etc.) within a queue; and/or

The creation or modification or addition of notes by an examiner, agent, applicant, computer system, or anyone managing, directing, or affecting any item within the queue in one or more queues.

Alerts may be sent to:

An applicant;

An applicant's attorney or proxy or other designated representative(s);

Anyone that is or might be affected by any submission or change to a submission and/or change within a queue and/or by any other factor for which an alert might be sent;

An agent;

An examiner;

Any third party that may be affected by any change to any item within the queue or otherwise or that has requested such alerts and/or has been authorized or otherwise instructed or expected to receive such alerts or information from the owner of such information, such as, for example, an applicant or agent and/or by the system and/or by rule, law, policy or otherwise;

The manager of the queue, which may be a person(s) or computer program or both;

A worker that must take some action in response to an Alert, e.g., a baggage handler;

The news media or a computer blog site, or a database for subsequent processing;

The court, or the clerk of the court;

Any third party that is authorized by the owner of the queue and/or by the applicant (as appropriate);

A second software application for further processing; and/or

A database for storage and subsequent retrieval and/or processing.

Alerts may be in the form of:

An e-mail message;

An Instant Message (i.e., IM);

A text or voicemail message;

A printed or displayed document sent via mail, registered mail, or express delivery and/or hand delivery;

A pager notification;

A record written to a database to be subsequently retrieved and/or reviewed, e.g., via a website;

A computer message or packet of data, for example, an XML document or a message sent using TCPIP;

A website page or database;

A telephone call, e.g., a cell phone call; and/or

A press release issued via any of the foregoing.

Controls On Queue Movement

In an embodiment, certain limitations on movements within or between queues may be established. Such rules may be established by the owner or manager of the queue(s) and/or via negotiations among those within the queue, or by a group of individuals chosen to represent those in the queue(s), by law, regulation, etc.

For example, applicants, applicant's attorney, agents, examiners or a third party may be required to do one or more of any of the following or none of the following, including:

Request a specific queue (or queue classification) at the time of submission, i.e., before assignment to a queue;

Request a change to a queue only after assignment to a queue;

Determine if they want priority processing or higher position in a queue either before or only after assignment, and/or perhaps, may only be offered such a choice one time and then only at a specific time, and/or one time, but at any time;

Pay for their application(s) up front and/or pay for theirs and at least one other applicant;

Pay for a subscription service to be eligible to request changes; and/or

Make requests only at certain times of the day, week, month or year.

There may be other constraints on applicants, applicant's attorneys, agents, examiners, third parties, etc. For example, any one or more of the forgoing may be constrained by any one or more or none of the following, including:

Being permitted to change position of a given application or group of applications 1 or n times for a given application or group of applications;

Allowed or denied to make change requests at specific steps, e.g., at the beginning, before or after initial assignment to a queue;

Certain applications or items may not be moved up or down relative to other applications or items and/or may only be moved, for example, once, or not more than X % or Y positions (i.e., up or down) in any given queue or within any proscribed period;

Certain queues may have restrictions established preventing an application from being moved within the queue and/or to another queue;

Applicants, applicant's attorney, agents, examiners or third parties, may be required to agree to certain conditions before receiving permission to move one or more applications or items within a queue and/or between or among queues. Such conditions may include: a) willingness to have part of all of the application published immediately or at a proscribed time prior to, during or after submission to a queue (e.g., upon examination), b) requirement to submit supplementary information or data at the time of submission or examination (e.g., attach all relevant and known prior art, after conducting a search and/or paying for such a search), c) requirement to provide additional narrative explanations, such as how the application is novel, or particularly useful, or satisfies certain laws or regulations as modified from time-to-time, or has significant social benefits, or is otherwise more worthy to receive priority processing, or additional explanations to demonstrate how it is non-obvious given the previously listed prior art, d) submission of a third party patent firm review of the application, i.e., one firm hires another to review the patentability of a given application and renders an opinion regarding such application), e) Submission of the application using a specific online patent drafting and filing system, and f) Submission of proof that applicant is eligible for preferential treatment or priority queuing based upon applicant's characteristics (such as applicant's age) or characteristics of applicant's application (such as demonstrating the inherent worth of an application, or proving the application suffers for great perishability in general or relative to other applications or items).

Such constraints may be determined by law, user groups, representatives, automatically (via rules or genetic algorithms), or by human judgment, or any combination of these.

Constraints may be represented by table entries or rules in a database of rules, which rules may be added, changed, or deleted by anyone authorized to conduct such changes within the rules database. There are many well known and documented methods in the prior art that describe how to establish, maintain, and execute one or more rules.

It would be obvious to anyone skilled in the art that additional constraints may be established in response to the program's effectiveness and/or behavior of applicants and/or examiners and/or their designees.

In an embodiment, an applicant may be required to make a payment to obtain an initial or revised position within a queue. Payments may be required or made:

Upfront;

Part upon submission and part upon processing;

All upon initiation of, or after processing is partially or fully completed;

Using credit card, cash, or certified check or money order;

Electronically or mailed or wire transfer;

Based upon the total expected;

Billed to an account with the processing office;

Third party payment processing agency, such as PAYPAL; and/or

A combination of any or all of the foregoing.

Position in Queues

Changes in position can be done manually (e.g., physically moving an item up or down in a stack of items, e.g., applications), or electronically.

Items in queues may be represented by a “placeholder” or tokens e.g., a unique identification number and/or a queue position number or both.

Expedited or priority processing may be accomplished by moving an item up in the queue, thereby moving the item closer to the top of the queue, or, by moving the item into another queue that contains fewer items, and/or items that are expected to be processed more quickly and/or to a queue that is established for the purpose of expedited or priority processing that may have more resources assigned to the queue as compared with the total number of items and/or the expected processing time associated with the total number of items, and/or those conducting the processing may be more skilled and/or have shown to be more efficient at processing items and/or such examiners may receive additional incentives and/or compensation to process items in a given queue or with a given status.

Movement in a queue may be restricted to only one position, or a set number of positions, a variable number of positions based upon applicant or applicants application's characteristics, and/or may not be limited.

Applicants may pay to move up one or more positions and/or pay a fee to be moved to the top of a given queue.

The fee (or compensation received) to move an application up (or down) within and/or between one or more queues may be determined based upon any one or more of:

Current or anticipated number of applications overall or within a given queue, or set of queues, or class of queue(s);

Total number of queues;

Total number of examiners (in a given queue, multiple queues, one or more classes of queue(s), with a given skill required to process the application(s), and or overall);

The open market, i.e., via an auction or reverse auction, or other bidding method;

Anticipated time required to process the application, and/or one or more of the other applications within a queue, and/or multiple queues, or classes of queues;

The size and/or complexity of a given application;

The amount of prior art and/or other materials attached to an application;

The worth of the application, e.g., the value of an insurance claim, or the estimated size of the market;

The “perishability” of an application as demonstrated or claimed by the applicant and/or determined by an examiner (e.g., the cost to move up a highly perishable application may be lower than that of something that is non-perishable, or it may be free);

The age or other discriminating factors of the applicant and/or the application;

By law or regulation;

The cost required to pay some or all of those that would or could be adversely affected by such a change;

The cost charged by the “owner” of a given slot, to give up that slot and be moved to the start of the queue and/or some other position;

Encourage or discourage movements or changes within one or more queues, e.g., if too many changes are occurring, the price may be steadily or dramatically raised, once, or multiple times, on a permanent or temporary basis, to dissuade applicants for making further change request;

Maximize revenues given the current, anticipated, or long-term demand for such change requests, e.g., open market forces; and/or

The amount of time an applicant's attorney has spent volunteering to review other applications to assist the examiner in determining if an applicant deserves processing and/or the issuance of a patent. E.g., if an attorney will review applications that do not represent a conflict in interest to his client's application, such attorney may receive credits for such volunteer work. Such an attorney may use part of all of accrued credits to expedite processing of his client's application and/or to “pay” another third party attorney to conduct an initial review of his client's application (with or without additional cost) depending upon the number of credits accrued vs. the number required by such third party attorney to conduct such a review.

Once initial processing of an item is started and/or completed, such as, for example, after an application is converted to an image file wrapper, as previously discussed above, the item may be removed from the queue, assigned to another “processing” or category queue, or moved to a new queue for review or examination. For example, after a first examination is completed, i.e. after the issuance of a first office action, it may be moved into a new queue for rejected applications where it awaits a response to the office action. There may be only one queue for rejected applications, and/or any number of queues, which may mirror the initial processing queues, and/or may be a different structure from the initial queue(s). For example, rejected applications may be segmented between those that paid for expedited processing and those that did not pay, and/or using any other discriminating characteristics as previously mentioned, and/or additional characteristics, for example, a new characteristic might be the type of rejection, e.g., the application is obvious (which might be a more severe form of rejection than, say, rejection due to certain informalities) or whether rejection was made ‘final’ or not.

Furthermore and as previously discussed above, once a response to an outstanding office is received, such as, for example, an amendment is filed, the application can be placed into a new queue comprising similar applications awaiting review of amendments, referred to as, for example, the regular amended application queue. Such applications can be processed in order of the filing date of the amendment, with an examiner being required to act on the amendment within a certain period of time, such as, for example, within two months of the filing date of the amendment. However, if a fee for expedited processing has been paid, that application could be moved to the top of the queue thereby requiring the examiner to act on the amendment as soon as possible, such as, for example, during that accounting period or bi-week. Alternatively, an application in which an amendment has been filed and a fee for expedited processing has been paid, could be placed in a queue comprising only amended priority processing applications which would require an examiner to process such applications immediately, such as, for example, during that accounting period or bi-week, or sooner.

Once in a “new” queue, if applicable, applicants may continue to receive priority treatment, and/or the process may simply proceed on a FIFO basis and/or applicants may be permitted to again “pay for priority” all according to the same or different rules as indicated previously.

For example, upon receiving a rejection, a ‘final’ rejection or otherwise, an applicant may wish to pay to have the application reviewed under appeal more quickly than some or all other applications awaiting appeal. In an embodiment, only those that paid for initial expedited or priority processing are permitted to be eligible for prioritized appellate processing, while, in yet another embodiment, any applicant can pay for such prioritized appellate processing even if such applicant did or did not pay for initial priority processing. In yet another embodiment, those that paid for initial priority processing are barred from paying for prioritized appellate processing and only those that did not pay are eligible to pay for prioritized appellate processing after initial processing, or vice versa.

In another example, upon receiving a rejection, a ‘final’ rejection or otherwise, an applicant may wish to file a continuation application or any other type of application, such as, for example, a divisional or continuation-in-part application, which claims priority to the original application so as to continue prosecuting that application or a related application to issuance. An applicant may wish to have such continuation application or similar application examined more quickly than some or all other applications awaiting examination. In an embodiment, only those that paid for initial priority processing are permitted to be eligible for priority processing with respect to related applications, while in yet another embodiment, any applicant can pay for such priority processing even if such applicant did or did not initially pay for priority processing. In yet another embodiment, those that paid for initial priority processing are barred from having their related application prioritized and only those that did not pay are eligible for priority processing of their related applications.

Pausing—Application Delays

Owners of a position in a queue (e.g., a token) may choose to temporarily postpone processing of their application. This may be permitted by those who have and/or who have not paid for priority processing. This may be desirable in the case where an application proceeds more quickly through the queue than expected. In such a case, applicant(s) may wish to have more time to modify their application prior to processing.

Such a deferral may come with a price and/or applicant may be paid a price to delay such processing. According to an embodiment, delayed or deferred positions may be used by those wishing priority processing. In such cases, priority applications may be inserted in place of one or more delayed applications.

In an embodiment, applicants may choose to sell their position in the queue to a third party. In such case, the third party pays the owner of the token (or slot) a fee determined by, for example, the slot owner, and/or the third party applicant may also be charged a fee (equal to or a different amount) by the examining agency, for example, the U.S. Patent and Trademark Office. Such secondary fee may be for administrative costs and/or to allocate additional resources to process the third party application and/or one or more other applications within the affected queue.

Allocation of Payment

Payments may be used in part or in whole to:

Create, maintain, or modify a manual or automated system (or combination) to track and control applications;

Pay one or more applicants that may be adversely affected by a change in one or more queues;

To hire additional resources to develop, modify, and/or manage an automated or manual system and/or to perform examinations and/or to determine pricing and/or conduct searches, and/or communicate with one or more applicants or examiners or courts, etc.;

To pay incentives to examiners to expedite one or more applications and/or to improve quality or quantity of applications and/or to reduce number of appeals, and/or reduce the number of patents rejected in court;

To provide general sources of revenue to an examining body or other governing body, company, etc.;

To hire additional resources to focus on those unwilling and/or unable to pay for priority, and/or for those that meet some other form of discriminating criteria such as age and/or health of applicant, social value of application, perishability of the application, peculiar importance of the application to some branch of the public service, the subject matter contained in the application will materially enhance the quality of the environment or materially contribute to the development or conservation of energy sources.

Application Assignment

The method and timing of assigning an application after, for example, initial receipt and processing, to an examiner's docket or from a queue to an examiner include any one or more of assignment:

Of an examiner or supervisory examiner (or their designee) to a queue or a group of examiners or supervisory examiners (or their designees) to one or more queues;

An examiner or supervisory examiner (or their designee) to a specific application upon submission and/or at any other time. Assignment may be to the specific application and/or to the position and/or to a token or other placeholder;

Assignment of an application when it reaches the top or near the top of a queue (or any other designated position within a queue) to a specific examiner or supervisory examiner (or their designee);

Assignment of an application to an examiner type, which then may be satisfied by the next available examiner that satisfies the requirements;

From a pre-classification division, to one or more examiners or supervisory examiners (or their designee) in a ‘Technology Center’ corresponding to the subject matter of the application, and then directly or indirectly to a specific docket or queue of an examiner in an ‘Art Unit’ and/or ‘Work Group’ within the particular ‘Technology Center’ who will conduct the examination.

Any method selected (1-4 above), or random assignment to an examiner may be further based on various application and/or examiner or examiner availability or prior experience, expected or projected workload, and/or pricing criteria, which assignment may be based upon any one or more of the following including:

The nature, extent and scope of the application;

The relative experience of the examiner given the application in question;

The current workload of a given examiner and/or as compared with all other examiners and/or those other examiners with the same or similar or related skill and experience as necessary to examine the application in question;

The willingness of a potential examiner to accept payment to work overtime or to accept additional work and/or to accept the application given the projected deadline or processing start and/or finished date;

The examiner's projected or actual workload and/or vacation schedule;

The price paid to prioritize an application;

The total number in a queue and/or assigned to a given examiner or group of queues and/or group of examiners;

Randomly; and/or

Total time required or expected to process one or more or all of the applications within a given queue and/or within an examiner's backlog or projected queue or backlog and/or group of examiners and/or expected additional, yet unknown applications, and/or anticipated newly prioritized applications and/or anticipated new examiners paid for from general funds and/or prioritization processing fees, and the like.

Moreover, the appropriate examiner for a given form might be determined based upon relevancy scores of forms previously processed by the examiner, other forms reviewed and/or other forms pending for that specific examiner, and/or as or if requested by the applicant or applicant's attorney, and/or based upon similarity of cases, electronic communications, and/or the examiner's education, training or performance reports.

Requesting a Change to an Examiner

Applicants (or their representatives) may request the assignment of a specific examiner based upon various reasons, including, for example, prior experience, skill of the examiner, rapport with examiner, price requested for priority queuing by such examiner or other criteria including characteristics of the applicant, the applicant's item, the examiner, or other variables.

Applicants may also request a change from a previously assigned examiner for various reasons, including, for example, negative reasons or no reason, including any of the foregoing or for failure of the examiner to understand or promptly process the application, a subject matter conflict, another examiner had worked on other applications directed to similar or identical subject matter filed by the same assignee or inventor(s), and the like.

Examiners may request a change in assignments to one or more other queues, or be added or removed from a case or be assigned or excused from examining a specific item or a group of items. Such requests may be made for no reason or any one or more of the following, including: a) past experience with the application or similar or different applications, b) workload, c) experience in general, d) commitments to other paid priority items, e) lack of interest, f) lack of training, or g) lack of formal education in the subject matter of the application.

Viewing a Queue

Generally, any authorized person(s) may view an application, and/or its position in a queue, or other information via physical inspection and/or via a website constructed for such purpose and/or request such information over a telephone (e.g., receiving such information from a person in the case of a manual system or from a voice enabled computer, in the case of an automated system).

Information may be generally available to applicants for free, such as, through the U.S. Patent and Trademark Office's PAIR (Patent Application Information Retrieval) system, or for an additional charge, e.g., per view or subscription or annual fee, to any eligible person including an authorized applicant, examiner, system administrator, applicant's attorney, or assign. Information may include any one or more of, including: a) applicant name, b) number or case number, or docket number, c) token, d) application title, c) abstract or summary or synopsis, d) position in queue, e) number ahead of application in queue, f) number behind application in queue, g) number and amount paid for each position in the queue, h) price to move up or funds to receive to move down, one or more positions within a queue, i) price to be moved to another queue, or price to be paid to be moved to another queue, j) estimated time to process the application once it reaches the top of the queue, k) estimated time to reach the top of the queue, l) estimated time saved or lost by moving up or down within a queue or by moving to another queue and/or a different position within a different queue, m) estimated time saved or lost by changing examiners, or by remaining with the assigned or expected examiner and/or cost to add an additional examiner and/or the expected time saved by adding one or more additional examiners (generic and/or specific), n) estimated increase or decrease in cost to move up or down in a given queue or changing queues based upon current trends in requests for such transactions and/or open market prices and trends, o) number of type of alerts available and/or setup and any associated parameters, e.g., type of alert, date and time, alert criteria, e.g., if my estimate increases by 10% or more alert me, method of alert, e.g., send an e-mail if change is between 10% and 20% or more, plus send me a text message if the change is greater than 20%, or, notify me if I can improve my position or speed up my processing by 10% or more, or if the cost to do so drops by e.g., 10% or more since the last offer I received, p) newly added or published prior art (in which case the message may be an application number or the entire application), q) date/time an application was filed, r) notes and messages associated with the application, s) all activity associated with the application and/or other similar applications and/or other applications with the same or similar queue(s), t) estimated consequences for moving or changing an application's position within a queue, and/or to/from another queue, u) number of third parties willing to sell a better position in the queue and their asking price, v) information about third parties and their historical transactions, including previous transaction's price asked and priced accepted, and u) any other information contained or submitted with the application and/or provided later by applicant, applicant's attorney, or other designee(s), and/or by one or more examiners or otherwise attached or associated with the application and/or the queue and/or the examiner created by any of the forgoing and/or by the system that manages such applications and/or queues, e.g., time and date stamps, electronic signatures, images, files, documents, sounds, financial information, transaction data, review notes and the like.

Fees for such access to data may be varied based upon how much data is requested, and/or it may be a flat fee or some combination of these options. Certain or all applicants may receive basic access to limited information and pay only to access all or certain more valuable information and/or more detailed information and/or information regarding other applications and/or queues. Applicants may be precluded from receiving part of all of such information unless they have first agreed to pay for priority and/or have paid for a subscription to the basic service.

Data Collection

Data collection may be accomplished manually in written form, or may be handled via automated processing systems, such as via a website. Certain data may be submitted by the applicant, the applicant's designee (e.g., a patent attorney), an examiner and/or by automated means, e.g., recording a transaction type, user name, applicant name, time and date stamp, etc., for each transaction. See the list of data elements above for a sample, but not exhaustive listing of data types that could be collected and recorded via manual or automated means.

Making the Data Anonymous and/or Secure

In certain cases, certain data elements may not be required or desired to be disclosed. In such cases, the actual data may be made anonymous or, preferably, the system simply prevents disclosure of certain data types or specific entries. For example, if an applicant accesses a queue for the purpose of determining his position and cost to change such a position, certain data elements may not be viewed by such an applicant, such as, for example, other applicant's mailing addresses or telephone numbers, but, perhaps, applicants could see other applicant's queue position and type of application, but, may or may not be able to see such third party's application name or summary (unless flagged as available for public viewing).

Each data element and/or transaction may be flagged as any one or more of, including: a) public, b) semi-private (applicant, examiner and applicant's designees only), c) owner's or examiner's eye's only, d) secure (i.e., for file only), e) or any combination of these and other classifications. Such classifications may be established by the examining agency, or by applicants or their designees, and/or by other regulation or law, or by a group of users or examiners charged with the duty to establish such procedures, or any combination of these methods.

Certain users or classes of users of information may only see certain elements and be restricted from seeing other elements, while other classes may be able to see all the elements or different groups of elements. It would be obvious to one skilled in the art that a system could be established to classify each user type, assigning each with a set of rules that determine which data elements are accessible, viewable, printable, changeable, etc., as such security systems are well known and described in the prior art and are well understood by those that develop such systems.

Processing an Application

As previously discussed, a system may automatically assign an examiner or this may be done by a supervisory patent examiner (or his designee). Applications may be examined in order from top to bottom and/or based upon priority and/or social value, and/or other discriminating factors, as previously discussed. Once it is determined that an application(s) is to be reviewed by a given examiner(s), a notice can be sent to the examiner and/or the examiner may request information when he/she is ready to take the next application.

The examiner can then receive and/or access the application (printed and/or in electronic form). The examiner reviews the application and may: a) add notes to the application or image file wrapper or case file (as applicable), b) communicate via notes, e-mail, IM, telephone, txt message, voice mail, etc., directly with applicant and/or applicants' designee or attorney (as appropriate and applicable), c) reject the application, or d) request information from the applicant.

When the application starts the review process, it may be considered as still being “in the queue” or it may move to a new “in process” queue. If it exits one queue, it may later be placed back into the queue (at the start, end or some other location). Such placement may be determined based upon the review process, the price paid to process the application, randomly, or by any other rules established by the examining agency or by other rule of law or regulation. Such replaced applications may be subject to further charges and may or may not be allowed to affect its position in the queue again. If the application moves to a “processing queue” such queue may or may not allow for subsequent priority processing using the same or different methods to determine the cost for such changes, if any.

If it is removed from the queue, and subsequently desires re-entry to the same or another queue, such re-entry may or may not be guaranteed and the position of such re-entry, if allowed, may or may not be based upon previous payments and/or notes or recommendations of the examiner. In an alternative embodiment, such re-entry to a queue or subsequent queue (i.e., an appellate queue), may be guaranteed with or without charge, which charge (if required) may be the same or different from all previous charges (individually or collectively).

Queue Movement Consequences

Affect of Moving an Application Ahead of Other Applications in a Queue

According to an embodiment, in the event that one item is prioritized over or above another item, certain rights, benefits, protections, or constraints may be imposed or bestowed upon the owner of the item that was adversely affected (i.e., the item not prioritized or replaced within a queue, a.k.a. “bumped”). For example, an item or item that has been bumped may not be eligible for any further bumping or there may be a limit to the number of times and/or number of positions that one or more items within a given queue can be bumped. This may be true in the reverse as well, e.g., once an item as been bumped up (i.e., given higher priority than one or more other items), then, for example, that item may no longer be eligible for subsequent improvement over other items.

Other benefits, limits or constraints may include any one or more of the following instead of or in addition to those listed above, including:

Maximum or minimum movement limits for one or more items, whether paying for priority or not;

Limits imposed after an item has been improved (i.e., bumped up) or loses one or more positions (i.e., bumped down) within a queue; and

Limits on the number of position change requests a given applicant or other person can make for a given: a) item, b) period of time, c) queue, d) queue group or queue category, e) group of items or f) an applicant's lifetime.

An end user whose item might be bumped up or down in a queue as a result of the prioritization of another item, may be provided with a right-of-first refusal. The right-of-first refusal may permit the adversely affected end user to block or prohibit another end user's request for prioritization. In such case, the adversely affected end user may be permitted to pay the same amount expected from such second end user, or some other amount, in order to prevent the prioritization of the second end user's item within the queue. If such a right is not exercised by the adversely affected end user, then the second end user's item is allowed to be priority queued. In an embodiment, the failure to exercise a right-of-first refusal can include acceptance of a fee or other consideration by the adversely affected end user in order to have the right-of-first refusal waived.

Limits on the number or modification of the price of/for subsequent changes to any one or more of: a) one or more or all items in a queue, b) certain classes of items in a queue (e.g., those submitted by senior citizens or the poor), c) number of positions one or more items in a given queue may be further modified, d) number of requests for any one or more applicants and/or based upon discriminating factors such as applicant's age or relative perishability of applicant's item(s).

Once a queue is established, at any time, certain end users, applicants or items may receive additional benefits and/or may be subject to constraints created by any governing or other body that has such authority, e.g., an insurance company or airline. Such benefits, rights, or constraints may be created and entered into the system by way of database tables or rules designed for such purpose. Such rules may include information such as any one or more of the following, including: a) item filing date, b) applicant information, e.g. applicant's age or income c) agent information, d) previously processed items, e) errors in processing, f), maximum number of changes per queue or period of time, g) pricing information, h) queue number and type, i) number and type of queue categories, j) any other data element listed in the databases and rules databases below, or any other variable as determined by the controlling or governing body or owner of the processing system or queuing application.

Pricing Queue Positions

Prices to change or maintain a position in a queue, in addition to those previously mentioned can be determined by:

Auction or reverse auction, which may or may not be an automated process. Sealed bidding processes that occur periodically, e.g., monthly;

A computer system that automatically modifies the price required to move an item up or down within a queue (or, as applicable within or between queues), and which, furthermore, measures the success of such pricing, e.g., by measuring the rate at which changes are made to positions, or via a combination of these methods. For example, an initial auction may be offered to the public so as to ensure the broadest dissemination of the notice, and then, based upon the final accepted prices, subsequent pricing can be based upon the prices established via such auctions.

Pricing may be determined by the system by balancing the number of change requests with the requested pricing. For example, the system may strive to optimize the price vs. change requests. This may be accomplished by: a) setting the price to a very high level and then b) gradually lowering the price over time until approximately ¼ to ½ of applicants are paying the requested price to move their applications up in a queue. Such ratios and pricing may be automatically determined using basic “price elasticity” calculation models and/or in combination with user definable pricing levels to determine the price to move one or more positions up or down within a queue.

Alternatively, or in addition to those listed above, pricing may be established at a fixed price by the processing agency and/or a user group and/or a combination of these or any other individual or governing body authorized to establish such pricing. Fixed pricing may be permanently fixed, and/or adjusted from time-to-time automatically (using any of the above methods) and/or manually.

Futures for Queues or Positions within Queues

In the case where application queues and/or positions within queues are accessible to the open market, pricing for positions will adjust themselves based upon the confluence of such issues as the total number of queues, applications, examiners, time to process each, etc., and the relative value of the applications versus the market price. Once such market forces emerge and take control over such pricing and systems, it is anticipated that, as with any other commodity, there will be those that speculate on the relative value and the short or long term value of such a commodity. Therefore, it is assumed that an automated exchange for such queues and positions within such queues may emerge or be created within the examining agency, and/or, absent a formal internal system, informal or third party exchanges will likely take root. It is conceivable that certain applications will be filed purely for the purpose of holding a position within a given queue.

Of course rules, regulations and laws may be passed to curtail or, perhaps, prevent such exchanges, but, applicants feel that such rules and laws are unnecessary and that market forces would best control the process.

In the case of a formal system contained within the examining agency, which may be the preferred method as value would be fully retained within the system, and regulation of the exchange is more likely and is more likely to be both secure and protect those unable to pay for priority processing, applicants or other third parties may speculate as to the future value of examining resources and the value of given positions within a given queue. Such an exchange could charge speculators a fee based upon each transaction, which fee could be a set fee in dollars or, alternatively, it could be based upon a percentage of the transaction value. Collection of the fee could be at the time of the purchase of a futures contract and/or at the time of the sale of one or more positions within one or more queues, e.g., the buying and selling of tokens made available at some future date for an expected price.

Proceeds from the collection of “broker's fees” could be further utilized to ensure adequate examination resources, which should tend to minimize or thwart rampant inflation or price gouging for available positions.

The examining agency itself could hold back certain “phantom” positions or tokens, and/or artificially increase or decrease the number of available positions or tokens based upon the market price and the availability of resources given the market pricing. Certain tokens could be created intentionally at differing price points and made available randomly and/or on a discriminatory basis, such as providing lower cost or no cost tokens to those showing need based upon for example, age, or societal value of the application or otherwise.

In another embodiment, an end user or applicant can submit a patent application to the patent office via a web-based central system. The system can determine the appropriate ‘Technology Center’, ‘Art Unit’, ‘Work Group’, and/or examiner within the patent office where the application should be queued for review as previously discussed above. Based on the other patent applications submitted to the particular ‘Art Unit’ and examiner, the system determines an estimated time when the patent office is expected to issue a first office action on the patent application. The system also displays how many patent applications are queued ahead of the patent application being submitted and generates a cost value to move the patent application up or down in the queue of patents requiring examination. The cost value of moving the patent application up or down in the queue is determined by the value assigned to the queue position of other patents in the same queue. At any time before the patent application is examined by a patent examiner, the end user or applicant can pay a cost value to move the application up or down in the queue of patents needing to be examined.

Even though an end user or applicant can pay to have his patent examined before other patents in the queue, the patent applications that are filed first are considered to be prior art for patent applications that are subsequently submitted. If any prior applications have high relevancy scores for the patent requesting higher priority, that request may be denied, and/or the relevant pending applications would be noted within the application and on the examiner's screen.

Examiners can cite submitted patent applications that have not yet been reviewed as prior art to patent applications that were submitted at a later filing date and are in the process of being examined.

In an embodiment, patent applications will not be allowed to be priority queued unless the end user who submitted them agrees to let them be published as soon as they are filed or at any other time.

If a patent application loses its place in queue because another patent application has outbid the first patent application, a notice can be sent to the end user or applicant allowing him to place a new bid on the patent application (with a right-of-first refusal granted according to original filing dates). Alternatively, as discussed above, the end user or applicant can be provided with the option of receiving the payment of a fee to waive the right-of-first refusal.

Patents that lose their place to an application with a high relevancy score can be permitted to submit commentary to the examiner explaining why their application should serve as prior art and/or invalidates a “higher priority” patent application.

It should be appreciated that a system configured to implement any or all of the above or below embodiments can be built utilizing many different architectural methods including: 1) a simple, table based method, 2) a rules based system, or 3) an artificial intelligence (AI) system such as one making use of one or more of a Neural Net, Bayesian or other Genetic Algorithm.

Alternatively or additionally, the system may simply be a manual process implemented in response to the creation of policies, procedure, and/or rules established by law or by the processing office, e.g., insurance agency or construction inspector's office.

Data Security

In an embodiment, certain or all data submitted, maintained, generated or otherwise included in one or more databases and/or as or when calculated, may be encrypted to prevent unauthorized use or disclosure. By generally implementing a certain degree of encryption protection, applicants may be assured that their personal or private data is not disclosed inadvertently and/or stolen or otherwise misappropriated or misused. The level of encryption used may be determined or based upon the sensitivity of the item, queue, or nature of the processing entity or organization. Anyone skilled in the art and familiar with encryption technologies, methods, and practice would be able to add such encryption. Various levels of encryption are readily available including open source encryption, such as, for example, PGP encryption available from PGP corporation, or encryption such as, for example, encryption available from Ambitware Technologies of Savoy IL, including their products I-Cipher and Armor System 5.

In another embodiment, certain data may be stripped or “cleansed” of certain identification information, for example, an applicant's personal data, before use or display to third parties. Thus, certain data may not be viewable by certain end users, or classes of end users, or disinterested third parties. Which data is to be cleansed, may be determined by the processing agency or other governing body, and/or may be partially or completely determined by the end user, i.e., end users may be permitted to indicate which information they are or are not willing to share with third parties.

### ALTERNATE EMBODIMENTS

The queue fee can be charged when the application or item is assigned a queue position, when the item is examined, or both in varying degrees.

The system could assign the application to an examiner or agent based upon the examiner's or agent's workload. The “appropriate examiner” might be determined based upon relevancy scores of the applications or items previously issued or processed by the examiner, other applications reviewed and/or other applications pending for that specific examiner.

In order to move an item or application up in the queue, for example, the end user could be required to be willing to fund the filing or processing fees of a particular number of end users or third party applicants who are not paying or who are otherwise unable to pay to move their items or applications up in a queue.

In another embodiment, items are immediately assigned to agents and prioritization can occur within that agent's queue and/or by transferring from a first agent's queue to a second agent's queue.

In yet another embodiment, end users, applicants, or others can place bids for groups of queue positions and/or queue groups and/or for specific queue positions. For example, a person (e.g. a large corporation or a speculator) may want to purchase several positions without driving the price up for queue positions in general. In an embodiment where there is some delay between a bid being posted (i.e., visible to other bidders and/or the seller) and/or where the queue position bid price is not posted during the period for bidding or at some other time, the bidder may submit a bid for one or a plurality of positions (e.g., the top 6 spots for $100,000 each). The queue position bid is then submitted simultaneously or substantially at the same time. In one embodiment, the multiple bids can be all withdrawn if one of the positions is lost (e.g. to a higher bid price and/or a position's item is processed in the interim, etc.).

In another embodiment, end users, applicants, or others, for example, bidders, may be permitted to simultaneously sell and buy one or more positions within a queue, and/or a right to purchase or sell a queue position in the future, and/or a right to swap positions of one or more items between or among multiple queues and/or queue categories. For example, a bidder can sell one queue position contingent on buying another queue position (within the same or different queues). For example, the bidder may have a position in a first queue but is willing to take profits by giving up his high-value position in either the first queue (or, in the alternate or in addition to, a second queue) in exchange for a lower position within said first and/or second queue, provided the bidder can actually receive a bid or payment for a lower position within the desired queue(s). In an embodiment, the lower queue position(s) can be defined by expanding, constraining, or other selection criteria (e.g. between positions 100 and 200), and bid price no more than $10,000, or no less than X positions from the current queue position, or no queue position that would increase the time to selection (i.e., top of the queue or point of processing) by more than X days, or Y % of time. If the bidder cannot get the desired or targeted or permitted lower queue position within the desired or target or acceptable queue (e.g., a first or second queue), the offer to sell his (higher) queue position may be withdrawn and/or modified to change the asking price and/or other selling terms.

In another embodiment, the examining office or owner or manager of the queue(s) and/or any other governing or authorized body, may establish rules that require that limited numbers of queue positions are available for auction or sale or purchase at any given time, and/or that those up for sale or purchase must be fully sold or purchased before additional queue positions and/or blocks of queue positions are made available for subsequent sale or purchase.

In another embodiment, if a first group or block of queue positions are sold or purchased, the examining office or owner or manager of the queue(s) and/or any other governing or authorized body, may establish rules that require that the entire first group or block of queue items (within said first group of block) be processed or examined before any examination or processing of said second group or block of queue items may be processed or examined. For example, if a group of the first group of (i.e., top) ten positions within an insurance claims examination queue is sold for $10,000 and a second group (i.e., positions 11-20) or block of positions within the insurance claims examination queue is sold for $5,000, the insurance claim processing agency may establish a rule, policy or guideline that requires that all the claims in the first queue are assigned/processed and/or examined before any of the claims in the second group are assigned/processed and/or examined. This embodiment can equally apply to anything that can be sorted into groups, including, for example, airline baggage, which may be sorted into groups such as: baggage paid priority first class, non-paying baggage first class, baggage paid priority coach class, and non-paying baggage coach class. In this example, baggage could be sorted according to the previous list either before or after the baggage is loaded on the airplane. For example, if sorting the baggage before loading the airplane, the baggage may be sorted in this order, so that when the airplane arrives at its destination, the baggage will come off the airplane and into the baggage carts, in the reverse order, i.e., leaving the paid, first class baggage generally to the front of the cart(s) and with the non-paying coach class baggage generally to the back of the baggage carts. In this way, when the baggage is then subsequently loaded onto the baggage claim area conveyor belt, it will be in such an order so as to ensure the proper delivery and timing of the various groups of baggage. In the case where the baggage may be directly unloaded from the airplane and onto the baggage claim area conveyor belt, the baggage may be sorted initially (i.e., prior to loading on the airplane) in the reverse order to the sorted priority. In this fashion, the non-paying, coach baggage will be loaded on the airplane first, and the paying first class baggage will be loaded last. Thus, when unloading the airplane at its destination, the baggage may be loaded directly onto the baggage claim area conveyor belt in the proper sequence.

In another example for use within the airlines, baggage that is to be transported to a second (e.g., connecting flight) at some mid-point, such baggage may be sorted to ensure that it may be generally offloaded from the airplane first (to speed routing to connecting flights) and/or sorted to be loaded generally in the back (to speed routing of prioritized baggage) and/or at some other point, or simply mixed with all the bags based upon their individual priority (whether paid or not paid), randomly, or some other priority basis, and/or manually sorted by the baggage handler and/or an automated sorting system as the baggage leaves the airplane and/or at some other sorting point or facility.

In another example, certain passengers may pay for their baggage to receive higher priority regardless of their cabin or ticket classification.

In another example, the price passengers are asked to pay for priority handling may be determined or affected (i.e., up or down in price and/or positions) based upon rules that expand and/or constrain or otherwise discriminate among passengers, and/or their baggage and/or the airline, flights, routes, etc., for example, the price of their ticket overall and/or in relation to others generally or others within the same cabin classification (e.g., coach, business, first class, or some other classification(s)), or other prices paid within the same flight, route, airline, other airlines, and/or based upon their current or expected status within a frequent flyer or other loyalty program, or their participation or status in a credit card or other buyer's club, and/or based upon the open market, e.g., bids placed on queue positions or classes of queue positions (e.g., first, second and third groups), past buying habits, willingness or ability to pay, and/or any other factors that can or do discriminate from among one or more passengers and/or their baggage over another one or more passenger's baggage, for example, the weight and/or number of bags.

In another embodiment, rules may be established that require that a certain ratio of item types be processed in sequence or in blocks or groups. For example, there may be a rule that a block of any ten items must require at least fifty percent of the items to be non-prioritized. Another example might be: when an examiner is assigned one priority queued (i.e., a paid for priority item), such examiner may not be permitted to review another paid for priority item until such examiner has reviewed at least one of any one or more items that are not paid, and/or those that may be otherwise discriminated in favor, such as the applicant's age. As another example, an examiner might be required to alternate between one application that has paid for priority and, three that have not paid, and then yet another that belongs within an underprivileged class, such as the poor. Such constraints may be made based upon, including any one or more of: the number of: items in a queue, total queues, groups or categories of queues, examiners, available examiners, items that have or are expected to pay for priority, items in the queue submitted by one or more classes of applicants, and/or by any one or more of: the time expected to process an item or group of items, or all items, or any of these within one or more queues, or groups or categories of queues, the revenue available and/or not available to process one or more items within one or more queues, and/or queue categories, and/or by law, rule, precedence, court order, policy, governing agency, queue management authority or company, or otherwise, and/or by any combination of the forgoing, any or all of which may be represented and determined, for example, using rules, e.g., constraints.

In an embodiment, sorting of items may be done manually or via an automated method, e.g., via bar code scanning of airline baggage.

In an embodiment, sorting of items may be accomplished via any generally known and/or widely, generally or privately available sorting algorithm, which may or may not be further affected by rules established within the present teachings, e.g., constraints and/or business rules.

In an embodiment, rules created may be designed to include certain items and/or may exclude certain items, prior to, during or after insertion and/or sorting and/or subsequent sorting, and/or processing, and/or rules may affect the sorting algorithm and/or may adjust the outcome of the sorting process either in absolute and/or relative and/or random terms. Any of the foregoing rules, may be identified as a rule type or rule code, and/or such logic may be built directly into one or more rules. Such rules may then be processed at the appropriate time and in the appropriate sequence, which sequence may be predetermined, ranked according to weighting or other calculation factors, randomly or controlled by a sequence number, and/or such rules may include verification or applicability testing or methods, e.g., apply this rule if and only if there are applicants that may be adversely affected and/or that participate or are eligible for a first right of refusal, or as another example, apply this rule to this sort list if the list exceeds 100 items, and/or the list includes applicants whose age exceeds 65, or includes applicants whose health is deteriorating rapidly or who may die within 5 years. As another example, a rule might include a test such as: apply this rule only if there are fewer than 5 bidders for a given queue position. Alternatively or in addition to the forgoing, the rule may indicate that it should not be applied if there are more than 50 bidders in a given auction for a given queue position. By the virtue of their flexibility, rules permit the system to modify its operating conditions in a flexible manner without necessarily adversely affecting the predictability or fairness of the system. The creation of rule based systems is widely known and is understood by those skilled within the art and other methods of design and implementation would be readily apparent to those skilled in the art.

In another embodiment, bidders may first be required to identify themselves, through verifiable means, such as submitting a copy of their driver's license, or passport, or birth certificate, or credit card or other financial account information, social security number or any other form of identification acceptable to the examining or processing office or agency.

In any embodiment and/or any alternative embodiment, the system can be built utilizing any one or more of the following different architectural methods, including: 1) a simple, table based method, 2) a rules based system, or 3) an artificial intelligence (AI) system such as Neural Net, or using Bayesian Algorithm, or 4) any combination of these as applicable.

The present disclosure provides numerous systems and methods related to management of items in queues. It should be appreciated that numerous embodiments are described in detail and that various variations, combinations and sub-combinations of these embodiments are contemplated by the present disclosure.

Hardware and Software—Patent Office System
a. Central Server may include applications such as:
   i. Agent Assignment Program—This program assigns an item or application to a given agent
   ii. Item Queue Program—This program assigns an item or application to a queue and queue position
   iii. Priority Queuing Program—This program permits changes to the initial queue position of an item
   iv. Alerts Program—This program continuously or periodically examines activities within any or all of the programs and/or databases and provides notices to persons or other applications of certain events occurring or expected to occur.
   v. Notifications Program—This program provides communications among and between applications and/or human beings or both.
   vi. Rules Engine—This program provides for loading, interpreting and processing of various rules and returns the results to one or more of the above programs. Such rule program may only return an approval or disapproval code or another value that is recognized by the calling application. This application may be replaced or augmented by any of a table based system or a genetic algorithm (GA) or multiple GA's.
   vii. Databases—Includes one or more of the databases listed below.
b. Clients may include applications such as:
   i. Browser or other I/O management application
   ii. Optional local database maintaining end user data, such as browser preferences, and/or part or all of below listed databases
   iii. Clients may optionally run part or all of any of the applications listed for the central server above.
   iv. Clients may be any handheld device, speaker, headset, microphone, desktop device, kiosk, cell phone, bar code scanner, or any other I/O device
c. Sorting Devices—may include applications such as:
   i. Baggage Handling Equipment, including bar code scanners
   ii. Mail sorters
   iii. Document scanning devices, and/or
   iv. Human beings

Databases

Item or Application Database may include information such as:
a. Item/Application ID
End User (e.g., applicant) ID
Other Ids—1-N
Item/Application Class
Item/Application Subclass 1-N
f. Item/Application Text/Notes/Abstract/Summary
g. Item/Application Profile
h. Item/Queue Assignment
i. Item/Queue Position Original
j. Item/Queue Position Current
k. Item/Application Priority Code
l. Requested Agent ID 1-N, with optional priority sequence
m. Assigned Agent ID 1-N, with optional priority sequence
n. Excluded or Flagged Agent ID 1-N, with optional priority sequence
o. Item/Application related documents 1-N
p. Calculated item/application value
q. Expected expiration date (e.g., perishability)

End User Database may include information such as:
a. End User ID
b. End User Password
c. End User Security Level
d. End User Security Group
e. End User Type
f. End User Qualification Class/Group
g. End User Billing Info
h. End User Contact Info
i. End User Personal Info
j. End User Security Information
k. Preferences Table 1-N (e.g., willingness to accept payment for positions in queue or willingness to pay for priority)
l. Payment history
m. End User's Date of Birth
n. End User's Annual Income
o. End User's Citizenship Status

Queue Position Database may include information such as:
a. Item/Application ID—1-N
b. Queue ID
c. Queue Category ID
d. Queue Position
e. Item Status (e.g., active, abandoned, delayed, priority level)
f. Pending or Assigned
g. Agent ID
h. Payment history 1-N

Agent Database may include information such as:
a. Agent ID
b. Agent Name
c. Agent User ID
d. Agent Password
e. Agent Security Level
f. Agent Security Group
g. Agent Type
h. Agent Profile
   (i) Items processed
   (ii) Items rejected
   (iii) Items overturned
   (iv) Proficiency scores
   (v) Preferences Table 1-N (e.g., willingness to accept fees for additional work or overtime)
i. Previously Examined Items 1-N
j. Errors in examinations 1-N
k. Current Division
l. Supervisor notes 1-N
m. End user notes 1-N

Item Queue Database may include information such as:
a. Item/Application ID Number 1-N
b. Agent ID 1-N
c. Queue Position Number 1-N
d. Fee for Queued Position 1-N
e. Pending change requests 1-N

Transaction Database may include information such as:
a. Transaction ID number
b. End user ID number
c. Patent Application ID number
d. Transaction Amount

Security Database may include information such as:
a. Security Level or ID number 1-N
b. Security Level Description
c. Transaction Types Authorized 1-N
d. Transaction Types Denied 1-N
e. Transaction Type Limits 1-N (e.g., $/%/ranges, etc.)

Queue Assignment Rules Database may include information such as: (For this and the following rules databases, rules may be user definable and/or described, for example, using the XML language. Rules may be processes in order of rule id number, or by rule priority number or sequence number. Anyone with ordinary skill in the art would appreciate that other methods to create, define and manage a rules based (a.k.a. expert system, or knowledge base or business intelligence) system are readily available and well understood. Furthermore, such rules could be replaced or enhanced using any of several widely known and understood algorithms such as genetic algorithms or Bayesian algorithms, which algorithms may or may not require an internal and/or external database of rules and/or which may generate rules automatically and, optionally compare such rules and results against business metrics or business objectives or other policies/laws/rules or objectives, including, for example, various fitness functions.) An example of a queue assignment rule is: If a queue position is open, include that position in a list of all possible assignment positions. Or, for example, a queue assignment rule might be: Upon inserting an item into an existing list of items, then move all affected items down and/or up (as applicable) one position. Yet another example, is: if baggage is to be loaded directly onto baggage claim delivery belt, then load baggage onto airplane in ascending order, else load baggage in descending order. A queue assignment or other rules database may include one or more of the following, but is not limited to a structured XML packet including one or more of a:
a. Rule ID
b. Rule Processing Sequence Number or Weighting Factor
c. Rule Description
d. Rule Details (e.g. if/then/else rules), and/or
A rule may include or point to other rules.

Priority Queuing Rules Database may include information such as: (This database is similarly structured to the ‘Transaction Database’ outlined above. An English language example of a Priority queuing rule might be: If the item's value may perish within one year, then permit priority queuing, else reject priority queuing based upon perishability. Another example of this type of rule might be: Has applicant filed all necessary forms, payments and releases, if not, deny priority queuing. Yet another example might be: If an applicant agrees to have their item published immediately and applicant has submitted additional documentation as required, then permit priority queuing of the item.

Assignment Constraints Database may include information such as: (This database is similarly structured to the ‘Transaction Database’ outlined above. An English language example of a constraint rule might be: If the applicant's age is greater than 21 but less than 65, then do not permit priority queuing preference based upon age, else permit age based priority queuing. Another example might be: If applicant already has more than X paid priority applications within a given queue (or alternatively all queues) then)

Fees/Payment Rules Database may include information such as: (This database is similarly structured to the ‘Transaction Database’ outlined above. An English language example of a Fee rule might be: If number of positions to move is equal to one, fee is equal to $5.00. If more than one position, multiply number of positions times $5.00 per position. Or, if item requires less than 10 hours to process, then fee is equal to $100 per position moved up, else fee is $20 per hour per position moved up.)

Optional/Alternative Fees/Payment Database may include information such as:
a. Fee ID
b. Fee Description
c. Fee Type Code
d. Fee Amount (Dollars and/or Percentage and/or equation and/or algorithm)

Agent Assignment Rules Database may include information such as: (This database is similarly structured to the ‘Transaction Database’ outlined above. An English language example of an agent assignment rule might be: If item requires list of skills X, then select only agents with X skills, else select agent with maximum % of X skills.)

Agent Change Request Rules Database may include information such as: (This database is similarly structured to the ‘Transaction Database’ outlined above. An English language example of an agent change request rule might be: If reason for change request is previous rejection by agent, then reject change request, else permit change request.)

Business Rules Database may include information such as: (This database is similarly structured to the ‘Transaction Database’ outlined above. An English language example of a business rule might be: If a given agent has more than Y items in a queue for processing, then prohibit assigning additional items to the agent. Or, if number of applicants requesting priority queuing is greater than X %, then increase the priority queuing fee by $Y or Z %.)

Payment Allocations Rules Database may include information such as: (This database is similarly structured to the ‘Transaction Database’ outlined above. An English language example of a payment allocations rule might be: If fee exceeds $X, then remit 10% of the amount greater than $X to the agent assigned, and 10% to a fund A (which, for example, might be a fund used to pay for other item processing for those that are unable to pay for such processing) and the balance to general fund.)

Agent Incentive Rules Database may include information such as: (This database is similarly structured to the ‘Transaction Database’ outlined above. An English language example of an agent incentive rule might be: If the item has been flagged for priority queuing, allocate 10% of the priority queue fee to provide an incentive for agent processing, if no agent retrieves the item within X amount of days, increase said incentive by 1% per week until item is picked up.)

Alert Rules Database may include information such as: (This database is similarly structured to the ‘Transaction Database’ outlined above. An English language example of an alert rule might be: if the price to change position in a queue falls below $X, or by Y %, send e-mail notice to all applicants requesting price drop notice alert. Or, another example might be: if by moving an item from an existing first agent's queue to a second agent's queue, the expected time to complete the processing of an item can be improved by more than X %, then notify all applicants with items awaiting processing in the first agent's queue.)

Security Rules Database may include information such as: (This database is similarly structured to the ‘Transaction Database’ outlined above. An English language example of a security rule might be: process applicant's submitted ID and determine if applicant is a valid US Citizen. Or, e.g., Determine if applicant is between the ages of 18 and 65, or, e.g., Retrieve applicant's profile and determine if applicant has a security access level of 5 or higher.)

Method Steps

In certain embodiments of the present teachings, the system may be configured to be executed any one or more of the following, in part or in whole, and/or in any sequence or no sequence as desired or applicable:

Priority Queuing Method

Alternatively or additionally, the system may be configured to create and manage one or more item queues by performing one or more of the following steps:
a. Display User Interface (UI)
b. Receive add/change/delete/action request(s)
c. Execute end user authentication method
d. If user is authorized, determine if one or more methods should be executed and the sequence for processing
e. Load all appropriate and/or necessary database(s) and, as applicable execute Load/Update Database Method
f. Execute methods listed below as required and in the appropriate sequence
g. Update UI as required
h. Update all databases as required using the Load/Update Database Method
i. Send notices, alerts, or messages as or when required.
j. Repeat method as necessary and/or in response to end user actions/requests and/or alerts

Initial Insertion into a Queue Method

Alternatively or additionally, the system may be configured to initially insert one or more items into one or more queues by performing one or more of the following steps:
a. Receive item for submission into a queue
b. Load assignment constraints database
c. Load Business Rules Database
d. Determine appropriate queue by executing “Initial queue assignment” method
e. Determine initial queue position within the queue by executing “Initial priority assignment” method
f. Update queue and other databases
g. Execute notification method

Initial Queue Assignment Method

Alternatively or additionally, the system may be configured to subsequently insert one or more items into one or more queues and/or manage one or more items/queues, by performing one or more of the following steps:
a. Receive request to determine queue
b. Receive or retrieve current item and applicant and other characteristics
c. Load queue assignment rules database
d. Determine appropriate queue type based upon rules and constraints databases
e. Determine time required to process pending items within existing/applicable queues
f. Assign item to best queue based upon estimated time to completion and available resources for a given queue
g. Insert item into queue at the start of the queue
h. Update queue and other databases
i. Execute notification method

Initial Priority Assignment Method

Alternatively or additionally, the system may be configured to initially assign priority or modify an item(s) position within one or more queues by performing one or more of the following steps:
a. Receive request for queue position assignment
b. Receive or retrieve current item and applicant characteristics and those of all other existing items, applicants, priority payments, etc.
c. Load priority queuing rules database
d. Load assignment constraints database
e. Determine initial queue position using rules databases and other variables and rules
f. If insertion point is other than the end (i.e., the lowest point within the queue), execute First Rights Method
g. If one or more third party First Rights are exercised and/or the insertion point for the item in the target queue is unavailable for any reason or no reason, then Execute notification method and return to calling application.
h. Otherwise, insert the item into the determined position in the target queue
i. Update queue and other databases
j. Execute notification method

Assigning Subsequent Priority to an Item

Alternatively or additionally, the system may be configured to subsequently assign priority or modify an item(s) position within one or more queues by performing one or more of the following steps:
a. Receive request to change queue position assignment
b. Receive or retrieve current item in queue and applicant characteristics and those of all other existing items, applicants, priority payments, etc.
c. Load priority queuing rules database
d. Load assignment constraints database
e. Determine if requested queue position is available and authorized using rules and assignment databases
f. If insertion point is other than the end (i.e., the lowest point within the queue), execute First Rights Method.
g. If one or more third party First Rights are exercised and/or the insertion point for the item in the target queue is unavailable for any reason or no reason, then Execute notification method and return to calling application.
h. Otherwise, if the requested item move is paid for (i.e, if necessary or required) and such move/insertion is authorized, then move (i.e., insert) the item into the queue to the determined position
i. Move all other items within the queue as necessary and as determined by this item queue position change request and any other rules and/or based upon First Rights Method outcomes.
j. Update queue and other databases
k. Execute notification method

Determining a Fee or Payment for Queue Position Change

Alternatively or additionally, the system may be configured to calculate a payment obligation for an initial or subsequent priority and/or queue position or queue assignment within one or more queues by performing one or more of the following steps:
a. Receive request for queue position change
b. Load fee/payment rules database
c. Determine fee or payment to change item queue position to requested item queue position based upon rules
d. Update queue and other databases
e. Execute notification method
f. Execute First Rights method
g. If no first rights claimed, await fee payment

Receive Fee for Queue Position Change

Alternatively or additionally, the system may be configured to determine and remit payments to, e.g., applicants, end users or other third parties by performing one or more of the following steps:
a. Receive payment for queue position change
b. Determine if payment is due other applicant(s) to accept change
c. Remit payment(s) due to applicant(s) if applicable
d. Move item(s) in queue based upon fees paid
e. Update queue and other databases
f. Execute notification method

Requesting a Specific Agent (in Advance of Item or Agent Assignment Methods)

Alternatively or additionally, the system may be configured to assign or reassign a specific agent or other person, e.g., an examiner, by performing one or more of the following steps:
a. Receive a request from an applicant or end user for a specific agent assignment.
b. Load agent assignment rules database
c. Load business rules database
d. Load assignment constraints database
e. Determine if agent is qualified for assignment to item
f. Determine if agent and/or item is constrained
g. Determine if any business rules would be violated with such assignment.
h. If agent and item satisfies all criteria, update item database to indicate agent preference.

Assigning an Agent to an Item

Alternatively or additionally, the system may be configured to initially determine, select and/or assign an agent, examiner or other person to one or more items in one or more queues by performing one or more of the following steps:
a. Receive indication that item has reached the top of the queue or other designated agent assignment point
b. Load agent assignment rules database
c. Load business rules database
d. Load assignment constraints database
e. Load Item database
f. Determine availability and workload (current and projected) of agents
g. Exclude “flagged” agents from consideration
h. Determine or evaluate other agent and item characteristics such as relevancy scores
i. Compare item characteristics and various scores with skill and experience levels and other characteristics of available examiners
j. Determine if incentives are available for processing item
k. Determine best available agent based upon agent assignment rules database and business rules databases and based upon applicant's preferences as previously submitted (if any)
l. Notify agents using notification method of possible assignment and incentives (if any)
m. Await acceptance notice (if required)
n. Assign agent
o. Update queue and other databases
p. Execute notification method (e.g. notify agent and applicant)

Agent Change Method

Alternatively or additionally, the system may be configured to assign or reassign a previously assigned agent or other person, e.g., an examiner by performing one or more of the following steps:
a. Receive request to change assigned agent
b. Load agent change request rules database
c. Load assignment constraints database
d. Determine if change is permitted
e. Determine if fee is required for change
f. If fee required notify applicant and await fee payment
g. If change is permitted and fee is paid, flag agent database to preclude agent from current or future consideration for request item and/or applicant (as applicable based upon the request type and change rules database)
h. Execute assigning an agent to an item method

Notification Method

Alternatively or additionally, the system may be configured to send one or more notices to one or more target recipients (e.g., a notice of allowance to an applicant, or a notice to request a computer application to perform a method step), by performing one or more of the following steps:
a. Receive indicator or instructions to execute notification method
b. Load communications rules database
c. Determine target recipient for communication
d. Construct message based upon rules database and/or communications request
e. Transmit communication to target recipient
f. Update queue and other databases

Alerts

Alternatively or additionally, the system may be configured to send one or more alerts to one or more target recipients, e.g., a notice to an applicant or agent, or other third party by performing one or more of the following steps:
a. Load alert rules database
b. Periodically examine queue and other supporting databases
c. Determine if alert condition has been (or, as appropriate, will be or is expected to be met)
d. Notify alert recipient(s) of alert via method established in alert rules
e. Include information regarding alert as defined in alert rules database

Viewing a Queue

Alternatively or additionally, the system may be configured to permit a request to view and/or to display or otherwise transmit data to authorized end users or other persons or applications, by performing one or more of the following steps:
a. Receive request to review a queue
b. Load user security database
c. Determine if request is authorized
d. Determine if such request if for free or for a fee
e. If a fee is required display fee amount and await payment
f. If authorized and paid, retrieve queue database information
g. If authorized and paid, display or output all or part of the queue database information

Determining a Fee or Payment for Queue Change

Alternatively or additionally, the system may be configured to calculate a payment or fee obligation for a moving an item from a previously determined queue to a new queue by performing one or more of the following steps:
a. Receive request for queue change
b. Load assignment constraints database
c. Load fee/payment rules database
d. Determine fee or payment to change queue based upon rules and constraints
e. Update queues and other databases
f. Execute notification method
g. Await fee payment

Receive Fee for Queue Change

Alternatively or additionally, the system may be configured to receive a payment obligation for an initial or subsequent priority and/or queue position or queue assignment within one or more queues by performing one or more of the following steps:
a. Receive payment for queue change
b. Determine if payment is due other applicant(s) to accept change
c. Remit payment(s) due to applicant(s) if applicable
d. Move item(s) to new queue based upon fees paid
e. Update queue and other databases
f. Execute notification method

Auctioning a Queue Position

Alternatively or additionally, the system may be configured to hold an auction on the sale or purchase of item positions within a queue, and/or for the transference of items between or among queues or queue groups, and determine one or more winners of such auctions by performing one or more of the following steps:
a. Receive request for queue position auction
b. Receive bids
c. Determine auction winner(s)
d. Update queue and other databases
e. Execute notification method
f. Await bid payment

Receive Bid or Other Payment for Queue Position Change

Alternatively or additionally, the system may be configured to receive, track and manage bids on the sale or purchase of item positions within a queue, and/or for the transference of items between or among queues or queue groups, and manage the changes of items and/or queues affected by such sale or purchase by performing one or more of the following steps:
a. Receive payment for queue position change
b. Execute payment allocation method
c. Move item(s) in queue based upon fees paid
d. Update queue and other databases
e. Execute notification method

End User Authentication Method

Alternatively or additionally, the system may be configured to determine and/or authenticate one or more end users' or other persons' security access level and/or determine which types of transactions such individuals are permitted to request, execute or process by performing one or more of the following steps:
a. Receive request to authenticate end-user (or other person or application)
b. Receive end user or other applicable ID
c. Load security rules and security log file databases
d. Determine if end-user (or other person or application) is authorized to make the request, and/or execute the application and/or process the requested transaction type, and/or send the requested alert, or otherwise based upon security rules database, and notify calling application.
e. Update databases (e.g., security log file)
f. Execute notification method

First Rights Method

Alternatively or additionally, the system may be configured to determine if one or more end users, applicants, or other third parties are entitled to first rights of refusal and manage notification and processing based upon such determination by performing one or more of the following steps:
a. Receive indication that item queue change is pending
b. Determine all other applicants/items that may be affected by such change
c. Notify all potentially affected applicants
d. Await request for first right of refusal
e. If valid request is submitted, notify original applicant of request
f. Determine if applicant will accept additional fee to forsake first right
g. Notify applicants if right is waived
h. If right is not waived, determine if additional fee to retain right is required
i. If fee required, notify applicant and await fee payment
j. If right is not waived and if required payment is made, prohibit item change or initial item insertion request (as applicable)
k. Update queue and other databases
l. Execute notification method

Process Items in a Queue

Alternatively or additionally, the system may be configured to process items within a queue, including determining if an item should be processed, assigning an agent and managing the items in the queue, e.g., removing the item from the queue by performing one or more of the following steps:
a. Receive indication that item has reached processing point, e.g., top of a queue
b. If not already assigned, assign agent to item for processing
c. Execute notification method
d. Submit item to agent for processing (which may include moving the item to a new “processing” queue)
e. Agent processes item
f. Remove item from queue (may require submission to subsequent “in process queue”)
g. Move all other items in the queue (e.g., up one position in the queue), except those flagged as being delayed
h. Update queue and other databases
i. Execute notification method

Delay Processing Method

Alternatively or additionally, the system may be configured to permit an end user, applicant, agent or third party to delay processing of an item or items in one or more queues or queue groups by performing one or more of the following steps:
a. Receive request to hold or delay position of item in a queue
b. Load delay rules database
c. Execute—Determining a fee or payment for queue change
d. If fee required, Execute Receive fee for queue change
e. If required payment is received or if none is required, flag item as delayed (e.g., time or number of positions)
f. Update queue and other databases
g. Execute notification method

Queue Position Sale

Alternatively or additionally, the system may be configured to permit the sale or purchase of a queue position, collect fees for such sale and transfer ownership of said queue position by performing one or more of the following steps:
a. Receive indication that position in queue is available for sale
b. Execute notification method
c. If applicable, execute Auctioning a queue position
d. Receive bid or other payment for queue position sale
e. Execute payment allocation method
f. Assign ownership of position to payer
g. If applicable, insert payer's item into purchased queue position
h. Update queue and other databases
i. Execute notification method

Payment Allocation

Alternatively or additionally, the system may be configured to distribute payments received to one or more recipients, including applicants, agents, third party, sellers of item positions and/or queue positions and/or queue groups by performing one or more of the following steps:
a. Receive indication that payment has been received
b. Load payment allocations rules database
c. Load agent incentive rules database
d. Determine if payment is due other applicants to accept change
e. Remit payments due to applicants if applicable
f. Determine if a portion or all of the payment is to be further allocated
g. Remit payments to recipients based upon allocation rules
h. Update queue and other databases
i. Execute notification method

Load/Update Database Method (Make Data Secure Via Encryption and/or Anonymous)

Alternatively or additionally, the system may be configured ensure that one or more databases comprised of one or more files, each with one or more data elements and other types of storage of data or media are current and accurate by performing one or more of the following steps:
a. Receive a request to retrieve or record data from/to a database and/or to display information and/or to create, modify or delete a database
b. Determine if requestor is authorized to perform requested action
c. If authorized and if data has been entered, determine if valid database exists and/or determine if the add/change/delete has been entered correctly, if not, request revision and return to start of method
d. If authorized and if recording data, encrypt the data and update the database accordingly
e. If authorized and if deleting data, delete the data accordingly
f. If authorized and if retrieving data for processing and/or display, decrypt the information and return the results to the requesting application for further processing or formatting, display, etc.

Those skilled in the art can appreciate from the foregoing description that the present teachings can be implemented in a variety of forms. Therefore, while these teachings have been described in connection with particular embodiments and examples thereof, the true scope of the present teachings should not be so limited. Various changes and modifications may be made without departing from the scope of the teachings herein.

What is claimed is:

1. A method comprising:
creating a document queue comprising a plurality of items;
assigning a queue position to each of the plurality of items based upon one or more determining factors;
calculating a fee for moving an item to a different priority queue position;
providing a right-of-first refusal for one or more items that would have their respective queue positions changed as a result of payment of the fee; and
moving said item to the different priority queue position in the document queue upon payment of the fee and a waiver of one or more right-of-first refusals.

2. The method of claim 1, wherein the different priority queue position is a higher queue position.

3. The method of claim 2, further comprising allowing commentary from applicants representing the one or more items that have had their queue position changed when the item that has been moved to the higher queue position is being processed.

4. The method of claim 1, wherein the right-of-first refusal includes a payment of a fee.

5. The method of claim 1, wherein the waiver of a right-of-first refusal includes acceptance of a fee.

6. The method of claim 1, further comprising denying the movement of an item to a different queue position based upon a particular level of relevancy between the item to be moved and one or more items which would have their queue position changed.

7. The method of claim 1, further comprising assigning the document queue including the plurality of items to a particular agent for processing.

8. The method of claim 7, wherein each of the items in the assigned document queue encompasses related subject matter.

9. The method of claim 7, wherein the assigned document queue assigned to the agent includes items in a priority queue position and items not in a priority queue position.

10. The method of claim 1, further comprising distributing at least a portion of the fee for moving an item to a different priority queue position to applicants representing one or more items to be processed.

11. The method of claim 10, wherein the applicants representing one or more items to be processed includes those whose items have had their queue position changed.

12. The method of claim 1, wherein the one or more determining factors includes time of receipt of at least one of the items.

13. A method comprising:
creating a document queue comprising two or more items to be processed;
assigning a queue position to each of the two or more items in the document queue based upon one or more determining factors;
determining a processing date for each item;
calculating a movement cost value for moving a particular item to one or more higher queue positions in the document queue; and
providing a right-of-first refusal for each item which would have its respective queue position lowered as a result of an accepted payment of a movement cost value.

14. The method of claim 13, further comprising moving an item higher in the document queue upon a failure to exercise one or more right-of-first refusals and the payment of the movement cost value.

15. The method of claim 14, wherein failing to exercise one or more right-of-first refusals includes the acceptance of one or more fees, respectively.

16. The method of claim 14, further comprising allowing commentary from the one or more corresponding items that have been moved down in the document queue when the item that has been moved higher is being processed.

17. The method of claim 14, further comprising denying the movement of an item higher in the document queue based upon a particular level of relevancy between the item to be moved higher and one or more items that would have their respective queue position lowered.

18. The method of claim 13, wherein the determination of a processing date for each item is based upon the number of items having a higher queue position in the document queue.

19. The method of claim 13, wherein the calculation of the movement cost value includes a determination of a range of cost values each corresponding to a number of queue positions an item can be moved.

20. The method of claim 13, wherein the one or more determining factors includes a date of receipt of at least one item with respect to a date of receipt of at least one other item.

21. A system of prioritizing items having filing dates comprising:
an assignment component capable of receiving two or more items filed by respective applicants and assigning a queue position for each item;
a document queue component capable of ordering the two or more items in a document queue by the assigned queue position, the document queue component being associated with an agent capable of processing the items;
a processing time component capable of ascertaining and notifying an applicant of a resolution date for each respective item in the document queue; and
a priority resolution component capable of determining whether an item has qualified to move to a different queue position based upon the payment of a priority queuing fee and the exercise of one or more right-of-first refusals by applicants who would have their respective queue positions changed as a result of payment of the priority queuing fee.

22. The system of claim 21, wherein the exercise of a right-of-first refusal by an applicant includes the payment of a fee.

23. The system of claim 21, wherein a failure to exercise a right-of-first refusal by an applicant includes acceptance of a fee.

24. The system of claim 21, wherein the priority resolution component is further capable of resolving the priority of a plurality of items in which priority queuing fees have been paid.
